(19) United States
(12) Patent Application Publication
(10) Pub. No.: US 2007/0120273 A1
(43) Pub. Date: May 31, 2007

(54) Method for disposing a conductor structure on a substrate, and substrate comprising said conductor structure

(75) Inventors: Gerald Eckstein, Munchen (DE); Wolfram Wersing, Bergen (DE)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, 80333 MUNICH (DE)

(21) Appl. No.: 10/587,982

(22) PCT Filed: Jan. 26, 2005
(86) PCT No.: PCT/EP05/50322

§ 371 Date: Aug. 3, 2006

(30) Foreign Application Priority Data
Feb. 3, 2004 (DE) 10 2004 005 255.7

(51) Int. Cl. B32B 9/00

(52) U.S. Cl. 257/E21.174; 428/408

(57) ABSTRACT

A separable connection is created between at least one transfer support and the conductor structure. The transfer support including the conductor structure and the substrate are joined together such that a connection that is stronger than the separable connection between the transfer support and the conductor structure is created between the conductor structure and the substrate. The separable connection between the transfer support and the conductor structure of the transfer support is separated while the connection between the conductor structure and the substrate remains intact. The method is particularly suitable for laterally disposing conductor structures comprising nanotubes at relatively low temperatures (T<600° C.), resulting in a substrate with a conductor structure which is connected to the substrate on a contact surface of the substrate and at least one additional contact surface of the substrate. In the device, a conductor structure provided with nanotubes extends between the two contact surface of the substrate, said nanotubes being oriented from a first contact surface of the substrate to a second contact surface of the substrate. The nanotubes are arranged laterally such that nanowires are created, allowing the excellent electrical and thermal properties of the nanotubes to be utilized.

### CROSS REFERENCE TO RELATED APPLICATIONS

This application is based on and hereby claims priority to PCT Application No. PCT/EP2005/050322 filed on Jan. 26, 2005 and German Application No. 10 2004 005 255.7 filed on Feb. 3, 2004, the contents of which are hereby incorporated by reference.

### BACKGROUND OF THE INVENTION

The invention relates to a method for disposing a conductor structure on a substrate. In addition a substrate with a conductor structure is specified which is connected to a substrate contact surface of the substrate and is connected to the substrate on at least one further substrate contact surface of the substrate.

The conductor structure is for example an electrical conductor structure with a metallic conductor track which is applied to the substrate with the aid of a screen printing method. The screen printing method is however not suitable for every type of miniaturization of the conductor track.

Carbon Nanotubes, (CNTs) and their application are known from P. M. Ajayan et al., Carbon Nanotubes, Topics Appl. Phys, 80 (2001) pages 391 to 425. Carbon nanotubes with functionalized tube surfaces emerge from A. Hirsch, Angew. Chem., 114 (2002), pages 1933 to 1939. Carbon nanotubes have a tube diameter in the nanometer range. The carbon nanotubes have a tube length ranging from micrometers to millimeters. The outstanding feature of these nanotubes can be a high electrical and/or thermal conductivity. Because of their small tube diameter, such nanotubes are suitable for producing the smallest conductor structures on the substrate. A very high integration density can be produced on the substrate surface. However there has not previously been any suitable method, for producing the smallest conductor structures with nanotubes on a substrate such that the major potential of the nanotubes could be utilized as regards miniaturization.

Nanotubes have previously largely been deposited using a CVD (Chemical Vapor Deposition) deposition process at a temperature of over 600° C. onto a substrate surface. The CVD deposition process is suitable for local structuring on a substrate surface, with however different structural and electronic modifications of the nanotubes being deposited at the same time. For example semiconducting and metallic conducting nanotubes are deposited. In addition nanotubes with different tube lengths are deposited as a rule. Above all no lateral deposition is possible, only horizontal deposition. With horizontal deposition the nanotubes are applied non-directed with a preferred direction to the surface of the substrate. The nanotubes are aligned in any direction in the plane. A requirement for a high degree of miniaturization however is lateral deposition in which the nanotubes are applied directed, that is with a preferred direction, on the substrate surface. With laterally deposited nanotubes the outstanding electrical and/or thermal properties of the nanotubes also come into their own in particular.

### SUMMARY OF THE INVENTION

One possible object of the present invention is thus to specify a method for disposing a conductor structure on a substrate which is suitable for obtaining lateral conductor structures of nanotubes on the substrate surface of the substrate.

The inventors propose a method is for disposing a conductor structure on a substrate with following steps: a) Making a separable connection between at least one transfer support and the conductor structure, b) Joining the transfer support and the conductor structure and the substrate, so that a connection between the conductor structure and the substrate is established which is stronger than the separable connection between the transfer support and the conductor structure and c) Separating the separable connection between the transfer support and the conductor structure of the transfer support, with the connection between the conductor structure and the substrate remaining intact.

In accordance with a second aspect of the invention a substrate is specified with a conductor structure which is connected to the substrate on a substrate contact surface of the substrate and on at least one further substrate contact surface of the substrate. The substrate is characterized in that the conductor structure between the two substrate contact surfaces features nanotubes which are aligned from the substrate contact surface to the further substrate contact surface.

The method for disposing the conductor structure can be called the transfer printing method. With the aid of a transfer support which acts as a template for the conductor structure a conductor structure is applied to the substrate (target substrate). To do this a conductor structure is first created on the transfer support. Furthermore the created conductor structure is transferred in a print process, preferably in a print-like process, from the transfer support to the substrate. The transfer support thus not only functions as a template but also as a pattern.

The method can be used to dispose any given conductor structure. The conductor structure is for example a thermal and/or electrical conductor structure. This type of conductor structure typically features an electrical conductor track with a wire made from a metal. In a particular embodiment a conductor structure is used which features nanotubes. It is possible using the method to apply the nanotubes of the conductor structure in an aligned manner to the substrate. In a particular embodiment a conductor structure is thus used in which the nanotubes in at least one section of the conductor structure are essentially aligned along a preferred direction. The section for example establishes an electrical and/or thermally conducting connection between two substrate contact surfaces. Within this section the nanotubes of aligned almost in parallel with each other. Small deviations of up to 20° from the parallel alignment are possible in such cases. The conductor structure is disposed laterally on the substrate by the nanotubes aligned in parallel with each other. This type of disposition allows the particular properties of the nanotubes, namely the small tube diameter of the nanotubes and the electrical and/or thermal conductivity along the direction or extension of the nanotubes to be exploited.

Any type of nanotube can be used for the method. Preferably the nanotubes are selected at least from the group of aluminum nitride, boron nitride and/or carbon nanotubes. A basic framework of the nanotubes is assembled from the said materials. A tube diameter amounts to a few nanometers. A tube length of the nanotubes is selected from the range of between 50 μm and 1000 μm inclusive. In particular the tube length of the nanotubes is 50 μm to 200 μm.

The conductor structure can be constructed from different nanotubes. In particular a conductor structure is used which is formed from one type of nanotube. One type of nanotube is identified by its specific chemical composition of the basic framework of the nanotube as well as by a specific tube length which can vary within defined limits, and by specific electrical and/or thermal properties. Thus it is possible to dispose only semiconducting or only metallic-conducting nanotubes between two substrate contact surfaces of the substrate. The length of the nanotubes is selected in this case so that the substrate contact surfaces are contacted by the nanotubes.

For the method for disposing the conductor structure on a substitute nanotubes are used especially which feature at least one functionalized point. Preferably each of the nanotubes has many functionalized points. A tube surface of the nanotubes is changed at a functionalized point. In particular a solubility of the nanotubes in a particular solvent is influenced by the change of the tube surfaces. This enables the method for disposing the conduct of structure to be undertaken using solutions or suspensions. For example nanotubes are functionalized with polar groups which lead to the nanotubes being able to be dissolved or suspended in a polar solvent. The polar group is for example a carboxyl group. The polar solvent is for example water. The functionalization of the tube surface enables the nanotubes to be dissolved in water. The functionalization of the nanotubes with unipolar groups is also conceivable, which make it possible for the nanotubes to be dissolved in unipolar solvents.

The functionalization can be undertaken chemically and/or physically. The chemical functionalization distinguishes between defect functionalization and sidewall functionalization. The defect functionalization uses defects (errors) in the basic framework of a nanotube. The nanotube is for example a carbon nanotube of which the basic framework is constructed from carbon hexagon rings. This carbon nanotube can feature defects in the form of carbon pentagon rings or carbon heptagon rings. These types of defects can be more easily attacked by a chemical substance than the regular basic framework of the nanotube made of the carbon hexagon rings.

The same applies to an open tube end of the carbon nanotube. In the functionalization an attacking chemical group therefore reacts to a defect or to a tube end with the carbon atoms by forming a fixed chemical bond. As with defect functionalization, with sidewall functionalization additional molecules or groups of molecules respectively are applied directly to the tube surface of a nanotube. By contrast with defect functionalization however it is not defects of the basic framework of the nanotube, but regular areas of the basic framework of the nanotube which are modified. In the case of the carbon nanotubes this means that carbon hexagon rings are functionalized. For sidewall functionalization especially reactive chemical substances are employed which coat the entire nanotube at more or less regular intervals with functionalizing groups. Sidewall functionalization has amongst other things a significant influence on the solubility of the nanotubes in a specific solvent.

With physical functionalization the nanotubes are given an additional shell with which they are loosely connected without formation of chemical bonds. The result is an aggregate formation between nanotube and relevant shell. The shellis formed of for example of at least one long a stretched polymer (macro molecule) which “enfolds” a nanotube. A special case of this type of functionalization is represented by the so-called “n-stacking” which is also referred to as “oriented adsorption”. In this case the encapsulating polymer only adheres to the relevant nanotube at particular points, whereas other areas of the polymer project freely into the space.

The conductor structure can be disposed directly on a transfer support substrate. To this end the transfer support substrate has transfer support contact surfaces to which the conductor surface is bonded. An immobilization (fixing) of the conductor structure is undertaken. The immobilization can be undertaken in this case through covalent bonds, through affinity interactions and through hydrophilic or hydrophobic interactions. The immobilization is performed so that it can be reversed. This means that the conductor structure can be removed again from the transfer support substrate. The connection between the transfer support and the conductor structure is separated again. The separation of this connection is undertaken for example by increasing the temperature or by the effect of a reactive substance.

A section of the surface of the transfer support substrate functionalized with a layer of gold is used for immobilization for example. This surface section forms the transfer support contact surface. If the nanotubes are functionalized with chemical groups which for example feature at least one sulfur atom, the nanotubes can be bonded to the gold layer. This results in the formation of gold-sulfur layers. The chemical group with at least one sulfur atom is for example a thiole or a sulfide group. Other layer materials can also be used for immobilization in addition to gold. For example a surface section is used which is coated with at least one of the metals selected from the group aluminum, copper, nickel and/or titanium.

In accordance with a particular embodiment a transfer support with at least one transfer support substance is used which features at least one transfer support contact point for establishing the separable connection between the transfer support and the conductor structure. The transfer support is composed of the transfer support substance and a transfer support substrate. Transfer support substance and transfer support substrate can be connected to each other and separated from each other.

The transfer support substance has the task of detecting a functionalized nanotube and bonding it to itself. Such a transfer support substance is for example a component of a two-dimensional (layered) chemical or biological recognition system applied to a transfer support substrate. This biological recognition system features anti-bodies or nucleic acids for example. The chemical recognition system is for example a hydrogel which is constructed from a polymer such as polyarcylamide. The antibodies, the nucleic acids and the hydrogel represent the transfer support substance in each case.

Preferably a transfer support substance is used which is functionalized to create the transfer support contact point on at least one point of the transfer support substance. The transfer support substance is in this case functionalized such that correspondingly functionalized nanotubes can be recognized and bonded in accordance with the “lock and key ” principle.

The transfer support substance can be linked in a first step to the conductor structure and in a subsequent step bonded to the transfer support substrate. For example the transfer substances and functionalized nanotubes are joined together in an aqueous solvent. The transfer support substances and nanotubes bond together in the solvent. A separable connection between transfer support substance and nanotube is formed in each case. In a further sequence the solution or the suspension respectively is directed past a transfer support substrate. The transfer support substance has further suitable functionalized points so that the transfer support substance with nanotubes can be bonded to the transfer support substrate.

It is also conceivable for the transfer support substance to be initially bonded to the transfer support substrate and subsequently to be connected to nanotubes of the conductor structure. For example, in a first step, a solution of the transfer support substance is directed past the transfer support substrate. This results in the bonding-in of the transfer support substance. In a subsequent step a solution with the nanotubes is directed past the transfer support substrate. The result is the bonding-in of the nanotubes to the fixed transfer support substance. Mixed forms of the sequence of bonding-in of transfer support substrate, transfer support substance and nanotubes of the conductor structure are also conceivable.

For functionalization of the transfer support substance and/or the nanotubes, for example groups with at least one Lewis base are bonded to the transfer support substance or to the nanotubes respectively. A Lewis base has a free pair of electrons. In a particular embodiment a functionalized point of the transfer support substance is used which features at least one sulfur atom. The sulfur atom which represents the Lewis base is provided for example by a thiole or sulfide group. Thiole or sulfides can bond very well to surfaces made of gold. It is also conceivable for a plurality of Lewis bases to be used. For example the functionalization is performed with the help of oligo-nucleotides (DNA oligos) made of in number of nucleotide units. The nucleotide units have a plurality of functional groups. These groups are Lewis acids, for example primary amines, and Lewis bases, for example aromatic nitrogen heterocycles. These Lewis bases and Lewis acids are suitable for example for forming hydrogen bridge compounds.

In a particular embodiment a macro molecule is used as the transfer support substance. A macro molecule (macro molecular substance) is formed of several hundred covalent bonded atoms. For example the macro molecule is an artificial or natural polymer (biopolymer). In a particular embodiment at least one macro molecule selected from the group deoxyribonucleic acids and/or protein is used. A Deoxyribonucleic Acid (DNA) is especially suited as a transfer support substance since it can be explicitly functionalized at particular points. With the aid of the explicit functionalization of the transfer support substance directed connection of the conductor structure with functionalized nanotubes on a support substrate and thereby a directed disposal of the conductor structure with the nanotubes on the target substrate is possible.

Advantageously for explicit disposal of the conductor structure with the nanotubes a macro molecule stretched lengthwise is used. The macro molecule stretched lengthwise stands out by virtue of its lengthwise extension. In this case the macro molecule can be formed from a one-dimensional more-or-less straight chain. The macro molecule stretched lengthwise can also be embodied as a helix.

It is also conceivable that a folded macro molecule rather than a stretched macro molecule is used for explicit disposal of the conductor structure with the nanotubes. The folded macro module forms a knot for example. In a particular embodiment a folded macro molecule is used to which is extended before it is joined together with the conductor structure. The stretching is undertaken before or during the formation of the separable connection between macro molecule and nanotube.

In the particular embodiment the folded macro molecule is stretched with the aid of a flowing fluid. This is successfully undertaken for example by the folded macro molecule being docked to a point on the transfer support substrate. The fluid flowing past, which can for example be a gas or a liquid, causes the macro molecule to unfold The macro molecule is untangled or stretched respectively. A fluid speed of the fluid is selected in this case so that the existing connection between macro molecule and transfer support substrate is retained. To this end a flow speed is advantageously selected which ranges from 0.1 μl/min to 500 μl/min. The corresponding volume of the fluid is fed directly past the transfer support substrate each minute. The macro molecule stretched in this way can now dock onto a further point of the transfer support substrate, with the stretched state of the macromolecule being “tied up” by the interaction with the transfer support substrate. Only then is the separable connection between the macro molecule and a nanotube established. Also conceivable is that, before the docking of the stretched macro molecule onto the further point of the transfer support substrate, a nanotube is connected to the stretched macro molecule. In this case the stretched state of the macro molecule is “tied up” by the interactions with a nanotube.

After the transfer support substrate and the conductor structure have been connected to nanotubes in a transfer printing process the conductor structure with the nanotubes is printed from the transfer support onto the target substrate. To this end the transfer support and the target substrate of bought close enough to each other so that as a result of chemical and/or physical interactions the connection is created between the conductor structure with the nanotubes and the substrate surface of the substrate. For connection a substrate with the least one substrate contract surface is used to establish the connection between the conductor structure the substrate Preferably before the conductor structure and the substrate are brought together, at least one section of the substrate surface is functionalized to establish the substrate contact surface. For example electrodes are applied to the substrate surface. With the aid of the conductor structures the electrodes are connected so that they are electrically conductive. In particular gold is applied to produce the substrate contact surface on the section of the substrate surface. The electrodes of the substrates surface are made of gold. It is also conceivable for the electrodes not to be made completely of gold but to feature an adhesive layer made of gold. Other coatings of electrically-conductive metals such as aluminum, copper nickel and titanium can also be used. Also conceivable is an adhesive layer made of a conductive adhesive which is applied to the substrate surface or to an electrode of the substrate respectively.

In general the process can be controlled explicitly with one or more adhesive layers. Thus in a particular embodiment for influencing a strength of the separable connection between the transfer support and the conductor structure and/or a strength of the connection between the conductor structure and the substrate an adhesive layer is used. With the aid of an adhesive layer the strength of the separable connection between the conductor structure and the transfer support can be reduced. By contrast, with the aid of a suitable adhesive layer, the strength of the connection between conductor structure and substrate can be increased:

The method described can be used for disposing a conductor structure on any given target substrate. Likewise a transfer support can be used with any given transfer support substrate. The relevant substrate is for example a substrate with a ceramic material. In the particular embodiment the substrate features at least one substrate material selected from the group semiconductor material and/or plastic material. A semiconductor substrate and/or plastic substrate is used. Precisely these types of substrate are sensitive to heat and can thus not be used for the known deposition of nanotubes with the aid of a CVD deposition process. The transfer print method described can be undertaken at a temperature which is far lower than the temperature of over 600° C. usually used in the CVD deposition processes. Thus temperature-sensitive substrate materials can also be considered.

A substrate formed in any manner can also be used as the transfer support substrate and as the target substrate. The substrate does not have to have any flat surface section on which the conductor structure can be disposed. In addition a substrate with an elastic substrate material can also be used. This type of substrate can be elastically deformed.

In summary the method and structure may produce the following major advantages:
It enables a lateral structuring of nanotubes at relatively low temperatures (T<600° C.).
Defined nanotubes or modifications of the nanotubes can be processed.
As a result of the explicit processing of specific modifications, optimum use can be made of the electrical properties of the nanotubes.
The method is low-cost and can be undertaken with minimal effort.

### BRIEF DESCRIPTION OF THE DRAWINGS

These and other objects and advantages of the present invention will become more apparent and more readily appreciated from the following description of the preferred embodiments, taken in conjunction with the accompanying schematic drawings of which:

FIG. 1 shows a substrate with conductor structure in a cross-sectional view from the side.

FIG. 2 shows a section of a nanotube from the side.

FIG. 3 shows a method for disposing of the conductor structure on the substrate.

FIG. 4 shows a method for producing a transfer support substrate which can be used for disposing the conductor structure on a substrate.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

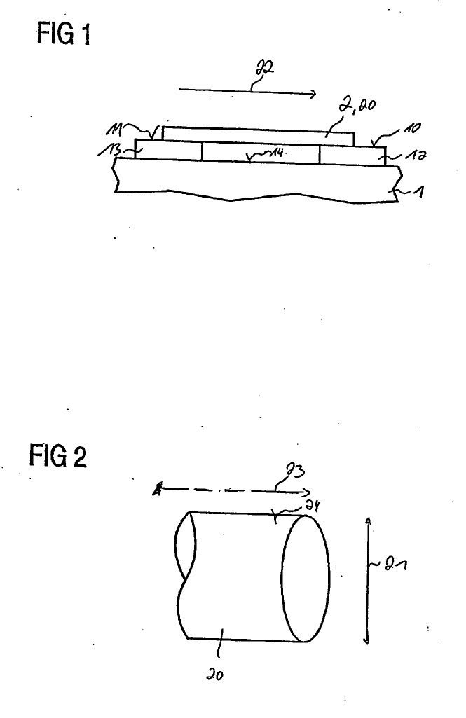

A conductor structure 2 is located on the substrate 1 (FIG. 1). The conductor structure 2 is connected via a further substrate contact surface 10 and a further substrate contact surface 11 with the substrate 1. The substrate contact surfaces 10 and 11 are formed by electrodes 12 and 13 made of gold.

The substrate material of the substrate 1 is a plastic. In an alternative embodiment to this the substrate material of the substrate 1 is a semiconductor material. The semiconductor material is Silicon.

The conductor structure 2 establishes an electrically-conductive connection between the substrate contact surfaces 10 and 11 of the substrate 1. To this end the conductor structure 2 features nanotubes 20 between the two substrate contact surfaces 10 and 11. The nanotubes 20 are aligned from one of the substrate contact surfaces 10, 11 to the other substrate contract surface 11,10. The nanotubes 20 have a preferred direction 22. This means that the nanotubes 20 are aligned laterally to the substrate surface 14 with the preferred direction 22.

In a first embodiment the nanotubes 20 are formed from one type of nanotube. This means that the nanotubes 20 are formed of a single tube material. The tube material is carbon. The nanotubes 20 are carbon nanotubes. The carbon nanotubes have the same tube length 23 (cf. FIG. 2). The same applies to the tube diameter 21 of the nanotubes 20.

In addition the nanotubes 20 of the conductor structure 2 stand out by having essentially the same physical properties. The nanotubes 20 of the conductor structure 2 are essentially metallically conductive. In an alternative embodiment to this the nanotubes 20 are essentially semiconductive.

In a further embodiment the conductor structure 2 is formed by different types of nanotube 20. The nanotubes 20 are distinguished by different chemical and physical properties 20.

In a further embodiment the nanotubes 20 are distinguished by different tube lengths 23. The nanotubes 20 are of different lengths.

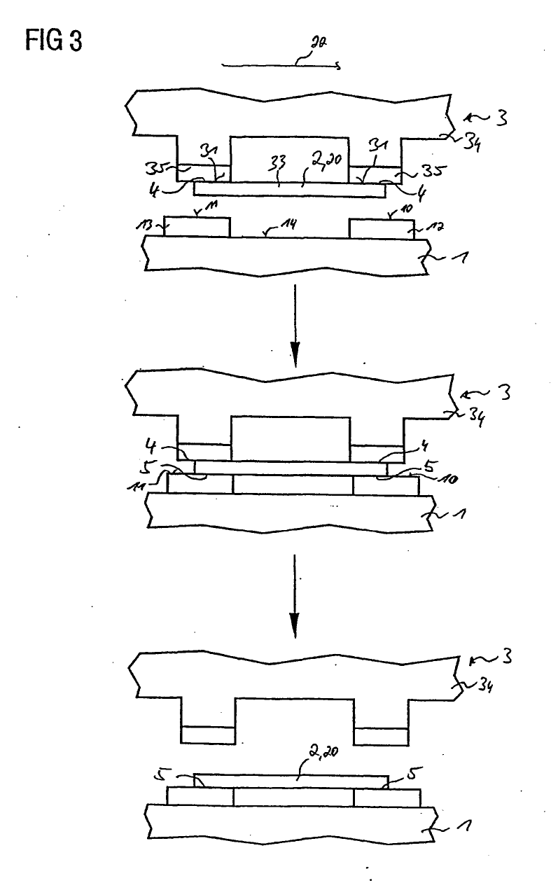

To dispose the conductor structure on the substrate the process is as follows (cf. FIG. 3): In a first step a separable connection 4 between a transfer support 3 and the conductor structure 2 is established. To this end the transfer support 3 has a transfer support substrate 34 and a transfer support substance 33 available. The transfer support substance 33 is a macro molecule in the form of a deoxyribonucleic acid. The transfer support substance 33 has a transfer support contact point (not shown). The transfer support contact point is a functionalized point of the macro molecule 33. The functionalized point of the macro molecule 33 has available a functional chemical group with a sulfur atom. The sulfur atom acts as a Lewis base and is formed from a thiole group. The transfer support substance 33 is connected to the transfer support substrate 34. To this end the transfer support substrata 34 has transfer support contact surfaces 31. The transfer support contact surfaces 31 are formed by an adhesive layer 35 of the transfer support substrate 34 made of gold. The transfer support substrate 34 is functionalized for forming the transfer support contact surfaces 31. At the same time the macro molecule 33 has a functionalized point for connecting the macro molecule 33 with the transfer support substrate 34.

The macro molecule 33 is initially a knot. This knot is stretched after connection to a transfer support contact surface 31 with the transfer support substrate 34 in the flow of a fluid. Functionalized nanotubes 20 are contained in this fluid. The nanotubes 20 have a tube surface 24 to which a chemical group is bonded. These functionalized nanotubes 20 are fed by the flow past the stretched macro molecule 33. The nanotubes 20 feature functionalized points which are suitable for entering into bonds with functionalized points of the macro molecule 33. Macro molecule 33 and nanotubes 20 are connected to each other. These bonds and the bonds of the macro molecule 33 to the transfer support substrate 34 are separable.

In the next step the transfer support 3, including the transfer support body 34 and the macro molecule 33 and which is separably connected to the conductor structure 2, is joined together with the substrate 1. The transfer support 3 and the substrate surface 14 of the substrate 1 are in this case brought so close to each other that the connection 5 between the conductor structure 2 and the substrate contact surfaces 10, 11 of the substrate 1 can be made. In this case a stronger connection 5 is made than the separable connection 4 between the transfer support 3 and the conductor structure 2. The separable connection 4 between transfer support 3 and conductor structure 2 is released. The conductor structure 2 is left intact on the substrate 1.

In a first embodiment the separable connection 4 is formed between transfer support 3 and conductor structure 2 of transfer support substance 33 and the nanotubes 20. After the separation of the connection 4 only the conductor structure 2 with the nanotubes 20 is left on the substrate 1. In a further embodiment the separable connection 4 is formed by the transfer support substance 33 and the transfer support substrate 34. After the transfer printing the transfer support substance 33 together with the conductor structure 2 is left on the substrate 1.

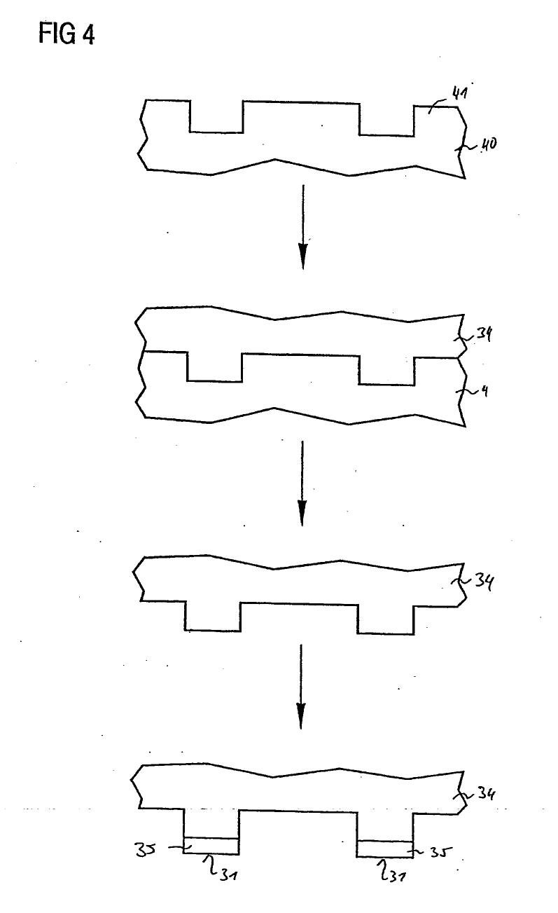

A prefabricated substrate can be used as transfer support body 34. FIG. 4 illustrates how the transfer support substrate 34 can be established via an auxiliary substrate 40. In this case a structure 41 is formed from the auxiliary substrate 40. A liquid hardenable polymer is used for the formation. After the hardening of the polymer the auxiliary substrate 40 and the hardened polymer are separated from each other. The hardened polymer forms the transfer support substrate 34 which can also be referred to as the master structure. To establish the transfer support contact surfaces 31 the adhesive layers 35 made from gold are applied. The transfer support substrate 34 established in this way is used to dispose the conductor structure 2 on the substrate 1.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v DIRECTV, 69 USPQ2d 1865 (Fed. Cir. 2004).

1-24. (canceled)

25. A method for disposing a conductor structure on a substrate, comprising:
establishing a separable connection between a transfer support and the conductor structure;
joining together the transfer support and the conductor structure to the substrate, to form a connection between the conductor structure and the substrate which connection is stronger than the separable connection between the transfer support and the conductor structure; and
separating the separable connection between the transfer support and the conductor structure, with the connection being left between the conductor structure and the substrate.

26. The method in accordance with claim 25, wherein the conductor structure has nanotubes.

27. The method in accordance with claim 26, wherein the nanotubes are aligned in at least one section of the conductor structure.

28. The method in accordance with claim 26, wherein the nanotubes are formed of a material selected from the group consisting of aluminum nitride, boron nitride and carbon.

29. The method in accordance with claim 26, wherein the nanotubes are substantially identical.

30. The method in accordance with claim 26, wherein each of the nanotubes has at least one functionalized point.

31. The method in accordance with claim 25, wherein transfer support has at least one transfer support substance that supports the conductor structure for establishing the separable connection between the transfer support and the conductor structure.

32. The method in accordance with claim 31, wherein the transfer support substance is functionalized for creating a transfer support contact point on the transfer support substance.

33. The method in accordance with claim 32, wherein the transfer support substance is functionalized with at least one sulfur atom.

34. The method in accordance with 31, wherein a macro molecule is used as the transfer support substance.

35. The method in accordance with claim 34, wherein the macro molecule is selected from the group consisting of deoxyribonucleic acid and a protein.

36. The method in accordance with claim 34, wherein the macro molecule is stretched lengthwise.

37. The method in accordance with claim 34, wherein a folded macro molecule is used which is stretched before the transfer support is joined together with the conductor structure.

38. The method in accordance with claim 37, wherein the folded macro molecule is stretched with the aid of a flowing fluid.

39. The method in accordance with claim 25, wherein the substrate has an electrical contact surface between the conductor structure and the substrate.

40. The method in accordance with claim 25 wherein before the transfer support and conductor structure are joined to the substrate, the substrate is functionalized to form a substrate contact surface.

41. The method in accordance with claim 40, wherein gold is applied to the substrate to form the substrate contact surface.

42. The method in accordance with claim 25, with an adhesive layer is used to between the transfer support and the conductor structure and/or between the conductor structure and the substrate.

43. The method in accordance with claim 25, wherein the substrate is selected from the group consisting of a semiconductor substrate and a plastic substrate.

44. An electrical device comprising:
a substrate having at least first and second contact surfaces; and
a conductor structure connected to the first and second contact surfaces of the substrate, the conductor structure having nanotubes which are aligned to extend from the first contact surface to the second contact surface.

45. The electrical device in accordance with claim 44, wherein the conductor structure is an electrical conductor structure.

46. The electrical device in accordance with claim 44, wherein the nanotubes are formed of a material selected from the group consisting of aluminum nitride, boron nitride and carbon.

47. The electrical device in accordance with claim 44, wherein all of the nanotubes are substantially identical.

48. The electrical device in accordance with claim 44, with the substrate is formed of a material selected from the group consisting of a semiconductor material and a plastic material.
